(19) United States
(12) Patent Application Publication
(10) Pub. No.: US 2025/0308375 A1
(43) Pub. Date: Oct. 2, 2025

(54) WEARABLE DEVICE-BASED PHYSIOLOGICAL DIGITAL BIOMARKER PREDICTIVE MODEL FOR PREEMPTING DISRUPTIVE BEHAVIOR IN CHILDREN

(71) Applicant: Mayo Foundation for Medical Education and Research, Rochester, MN (US)

(72) Inventors: Arjun P. Athreya, Rochester, MN (US); Paul E. Croarkin, Rochester, MN (US); Magdalena Romanowicz, Rochester, MN (US); Julia Shekunov, Rochester, MN (US)

(21) Appl. No.: 19/089,719

(22) Filed: Mar. 25, 2025

Related U.S. Application Data
(60) Provisional application No. 63/571,856, filed on Mar. 29, 2024.

(51) Int. Cl. G08B 31/00; G06N 20/20; G08B 21/02

(52) U.S. Cl. CPC G08B 31/00; G06N 20/20; G08B 21/0211

(57) ABSTRACT

Impending disruptive behavior in an individual is predicted using a machine learning model that processes measurement recorded with a wearable device. Measurement data are received from a wearable device and input to a trained machine learning model, generating predictive feature data as an output. The predictive feature data may include predictive scores, classifications, or the like, of a likelihood of a subject having a disruptive behavior.

### CROSS-REFERENCE TO RELATED APPLICATIONS

This application claims the benefit of U.S. Provisional Patent Application Ser. No. 63/571,856, filed on Mar. 29, 2024, and entitled “WEARABLE DEVICE-BASED PHYSIOLOGICAL DIGITAL BIOMARKER PREDICTIVE MODEL FOR PREEMPTING DISRUPTIVE BEHAVIOR IN CHILDREN,” which is herein incorporated by reference in its entirety.

### BACKGROUND

Evidence-based therapies such as Parent-Child Interaction Therapy (PCIT) reduce behavioral and emotional symptoms in children by improving parent-child relationships through the implementation of specific rules taught over a multi-week period. Despite the widespread availability of PCIT, its effectiveness is contingent upon parents consistently interacting with their children and making a concerted effort to implement interventions taught in PCIT. Accurate predictions of a child's impending disruptive behavior would provide an effective prompt for parents to implement appropriate PCIT interventions to potentially improve the child's behavior and parent-child attachment.

### SUMMARY OF THE DISCLOSURE

According to an aspect of the present disclosure, a method for predicting disruptive behavior in a subject is provided. The method includes receiving by a processor, measurement data recorded with a wearable device worn by a subject, wherein the measurement data comprise motion data, heart rate data, and sleep data. The method also includes accessing a machine learning model with the processor, wherein the machine learning model has been trained on training data to monitor signals contained in the measurement data to detect signals that indicate a likelihood of a disruptive behavior for an individual, wherein the machine learning model is a tree-based model, wherein the tree-based model is a decision tree model or a random forest model. The method further includes applying the measurement data to the machine learning model with the processor, generating predictive feature data that predict a likelihood of a disruptive behavior in the subject based on the measurement data. The method also includes outputting the predictive feature data with the processor, wherein the predictive feature data indicate predictive scores or probabilities of different behavioral phenotypes.

According to another aspect of the present disclosure, a method for training a machine learning model to generate predictive feature data that indicate a likelihood of a disruptive behavior in a subject is provided. The method includes accessing, by a processor, training data comprising measurement data acquired from wearable devices worn by a plurality of subjects, wherein the measurement data comprises at least one of motion data, heart rate data, or sleep data. The method also includes assembling, by the processor, the training data into a data structure, wherein the training data includes labeled data associated with one or more behavioral phenotypes. The method further includes initializing, by the processor, a machine learning model with initial model parameters. Additionally, the method includes training, by the processor, the machine learning model on the assembled training data by optimizing the model parameters based on minimizing a loss function. The method also includes storing, by the processor, the trained machine learning model for later use in predicting disruptive behavior in a subject.

### BRIEF DESCRIPTION OF THE DRAWINGS

FIG. 1 is a flowchart setting forth the steps of an example method for generating predictive feature data indicative of a predicted disruptive behavior in an individual by inputting measurement data acquired with a wearable device to a trained machine learning model.

FIG. 2 is a flowchart setting forth the steps of an example method for training a machine learning model to generate predictive feature data from measurement data.

FIG. 3 shows example variations of 15-minute moving average heartrate (and associated regression with 95% confidence interval) across behavior phenotypes.

FIG. 4 shows example instant heartrates across behavior phenotypes.

FIG. 5 shows example heart rate (solid blue line—instant heartrate; dashed red line—15-minute moving average) and intensity variations during the onset of a disruptive behavior.

FIG. 6 shows example variations in sleep on days with and without disruptive behaviors.

FIG. 7 shows an example decision tree to predict calm, playful, and onset of disruptive behavior.

FIG. 8A illustrates a Kaplan-Meier plot of dropout by treatment arm in an example study.

FIG. 8B illustrates variation of mean adherence (% time smartwatch worn per day) during study period stratified by child and participating parent. The shaded region is the 95% confidence interval of adherence.

FIG. 9A illustrates the difference in duration (in minutes) of tantrums between treatment arms in an example study.

FIG. 9B illustrates the difference in duration (in minutes) of tantrums between treatment arms and stratified by CDI and PDI phases of PCIT in an example study.

FIG. 9C illustrates the duration of tantrums between treatment arms during the course of the PCIT in an example study.

FIG. 10 is a block diagram of an example system for predicting disruptive behavior in an individual, such as a child.

FIG. 11 is a block diagram of example components that can implement the system of FIG. 10.

### DETAILED DESCRIPTION

Described here are systems and methods for detecting impending disruptive behavior in an individual using machine learning to process sensor data recorded with a wearable device. The disclosed systems and methods provide a framework for predicting disruptive behavior in children in order to preempt a child's extreme behavior of violence. In this way, improved emotional regulation, improved behavior, and/or an improved parent-child dyad may be achieved.

Using the systems and methods described in the present disclosure, measurement data from a wearable device and phenotyping of child's behavior in a controlled environment can infer associated digital physiologic biomarkers from a smartwatch or other wearable device. This framework utilizing digital biomarkers also has the prospect of providing a foundation for ecological valid interventions for improving contemporary family engagement and health. Light-weight prediction logic that can be programmed into low-cost smartphones connecting to smartwatches, or other wearable devices, can address current healthcare access challenges in child and adolescent mental health in a cost effective, patient-centered manner. However, embodiments in which some or all of the prediction logic is implemented on an external device (e.g., on an information handling device configured to operate as a cloud server) are also within the scope of this disclosure.

### Machine Learning Implementation

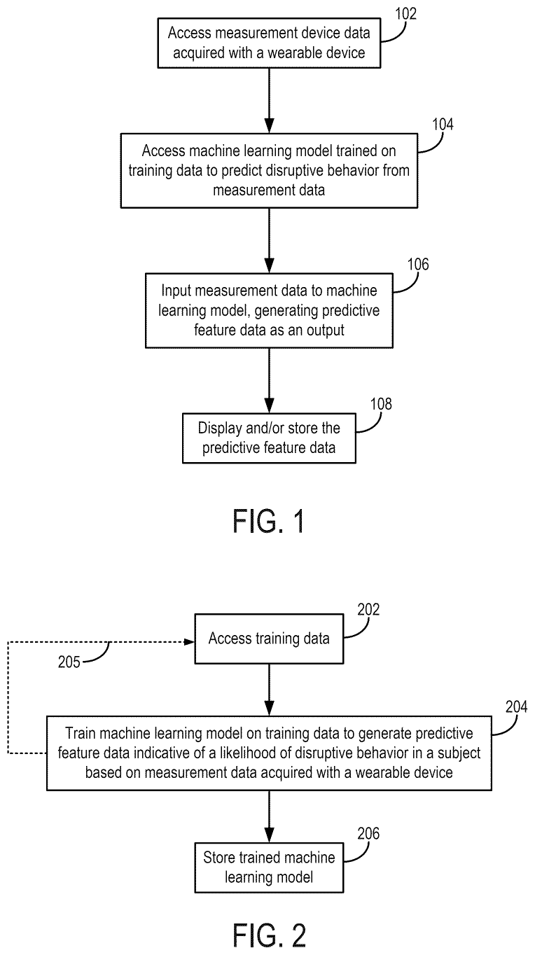

Referring now to FIG. 1, a flowchart is illustrated as setting forth the steps of an example method for generating classified feature data using a suitably trained machine learning model. As will be described, the machine learning model takes measurement data recorded by a wearable device as input data and generates predictive feature data as output data. As an example, the predictive feature data can be indicative of a likelihood of disruptive behavior in the subject based on signals in the measurement data. The measurement data can include one or more of motion data (e.g., accelerometer data), heart rate data, or sleep data. Additionally or alternatively, the time of day may also be recorded and used as an input to the machine learning algorithm.

### Accessing Data

The method includes accessing measurement data with a computer system or other processor, as indicated at step 102. Accessing the measurement data may include retrieving such data from a memory or other suitable data storage device or medium. Additionally or alternatively, accessing the measurement data may include acquiring such data with a wearable device (e.g., a smartwatch, a fitness tracker) and transferring or otherwise communicating the data to the computer system or other processor, which may be a part of the wearable device, an external device, a server, or the like.

The measurement data may include motion data, heart rate data, and/or sleep data acquired with a wearable device being worn by the subject. As an example, motion data can include measurements of motor activity (e.g., minutes spent being sedentary, active, or highly active; step counts; etc.); heart rate data can include measurements of heart rate, resting heart rate, or the like, measured in beats per minute; and sleep data can include sleep duration (e.g., total hours and/or minutes of sleep), sequence of sleep stages, time spent in each sleep stage, and the like. Additionally or alternatively, the measurement data may include other data measured with or recorded by the wearable device. As a non-limiting example, the measurement data may additionally or alternatively include respiratory rate data; skin temperature measurement data; electrocardiogramal data; blood oxygenation data; blood pressure data; stress level monitoring data; galvanic skin response data or other electrodermal activity data; muscle activity data (e.g., electromyography signal data, measurements of muscle tone); hydration monitoring data; posture monitoring data; blood glucose monitoring data; ultraviolet (UV) light exposure data; and the like. The measurement data may include individual measures of such data types, or may include one or more combined measures of the measurement data types.

### Accessing Trained Machine Learning Model

A trained machine learning model (or other suitable machine learning algorithm) is then accessed with the computer system or other processor, as indicated at step 104. In general, the machine learning model is trained, or has been trained, on training data in order to detect or predict the likelihood of disruptive behavior in a subject (e.g., a child) based on the signals in the measurement data.

Accessing the trained machine learning model may include accessing network or model parameters (e.g., weights, biases, etc.) that have been optimized or otherwise estimated by training the machine learning model on training data. In some instances, retrieving the machine learning model can also include retrieving, constructing, or otherwise accessing the particular machine learning model architecture to be implemented. For instance, data pertaining to the layers in the machine learning model architecture (e.g., number of layers, type of layers, ordering of layers, connections between layers, hyperparameters for layers) may be retrieved, selected, constructed, or otherwise accessed.

### Applying Data to the Machine Learning Model

The measurement data are then input to the machine learning model, generating output as predictive feature data, as indicated at step 106. For example, the predictive feature data may include a predictive score. The predictive score can provide physicians, clinicians, or other users with a recommendation to consider additional monitoring for subjects whose measurement data indicate the likelihood of the subject having disruptive behavior.

As another example, the predictive feature data may indicate the probability for a particular classification (i.e., the probability that the measurement data include patterns, features, or characteristics indicative of detecting, differentiating, and/or determining the phenotype of a disruptive behavior).

Additionally or alternatively, the predictive feature data may classify the measurement data as indicating a particular phenotype of disruptive or non-disruptive behavior. In these instances, the predictive feature data can differentiate between different behavioral phenotypes. In still other embodiments, the predictive feature data may indicate a severity of a disruptive behavior. For example, the predictive feature data may include a severity score that quantifies a severity of a disruptive behavior.

### Display and/or Store Output

The predictive feature data generated by inputting the measurement data to the trained machine learning model(s) can then be displayed to a user, stored for later use or further processing, or both, as indicated at step 108.

For instance, the predictive feature data can be presented to the user as a report indicating that a disruptive behavior is imminent, or as a report indicating to others that the user is experiencing or about to experience a disruptive behavior. Additionally or alternatively, the predictive feature data can be presented to the user as a report indicating that a disruptive behavior is imminent or otherwise predicted to occur within a duration of time (e.g., within the next 30-90 minutes), or presented as such a report to indicate to others that the user is likely to experience a disruptive behavior within that duration of time.

Based on these reports, a physician, clinician, or other user may intervene with therapeutic intervention to prevent or reduce the severity of the disruptive behavior. For instance, the user may provide emotional regulation to the subject to reduce or prevent the disruptive behavior.

As another example, an alert can be generated based on the predictive feature data and the alert can be sent to a user. The alert may include some or all of the predictive feature data, or may be a separate alert that is generated in response to, or otherwise based on, the predictive feature data. For example, the alert may be a text alert (e.g., a text message, an email, another text-based message). The text alert may include a message identifying that the subject is likely to experience a disruptive behavior within a duration of time (e.g., the next 30-90 minutes). In some instances, the text alert may include part of the predictive feature data in addition to a message, such as a predictive score, a probability of disruptive behavior, or the like. In other examples, the alert may include a visual alert, an auditory alert, and/or a haptic alert.

When generated, the alert may be sent to one or more parties. As one example, the alert may be sent to a parent or guardian of the subject. As another example, the alert may be send to one or more members of a health team for the subject. As still another example, the alert may be sent to the user. The alert may also be sent to more than one of these parties, for instance, to both a parent and a health team. The alert can be sent by a processor or other computing device, which in some instances may be a processor of the wearable device, to an external device, such as a smartphone, tablet computer, computer, or the like.

### Machine Learning Model Training

Referring now to FIG. 2, a flowchart is illustrated as setting forth the steps of an example method for training one or more machine learning models (or other suitable machine learning algorithms) on training data, such that the one or more machine learning models are trained to receive measurement data acquired with a wearable device as input data in order to generate predictive feature data as output data, where the predictive feature data are indicative of a likelihood of disruptive behavior in the subject based on signals in the measurement data.

In general, the machine learning model(s) can implement any number of different machine learning model architectures. For instance, the machine learning model(s) could implement a decision tree model, a random forest model, or the like. Additionally or alternatively, the machine learning model(s) could implement an artificial neural network, such as a convolutional neural network, a residual neural network, or the like. Alternatively, the machine learning model(s) could be replaced with other suitable machine learning or artificial intelligence algorithms, such as those based on supervised learning, unsupervised learning, deep learning, ensemble learning, dimensionality reduction, and so on.

### Accessing Training Data

The method includes accessing training data with a computer system, as indicated at step 202. Accessing the training data may include retrieving such data from a memory or other suitable data storage device or medium. Alternatively, accessing the training data may include acquiring such data with wearable devices and transferring or otherwise communicating the data to the computer system.

In general, the training data can include measurement data acquired from wearable devices, including motion data, heart rate data, and/or sleep data. Additionally, the training data may include other data, such as time of day data, subject demographic data, and the like. In some embodiments, the training data may include measurement data that have been annotated or otherwise labeled with behavioral phenotypes (e.g., labeled as containing patterns, features, or characteristics indicative of certain behavioral phenotypes).

The method can include assembling training data from measurement data using a computer system. This step may include assembling the measurement data into an appropriate data structure on which the machine learning model. Assembling the training data may include assembling measurement data and other relevant data. For instance, assembling the training data may include generating labeled data and including the labeled data in the training data. Labeled data may include measurement data or other relevant data that have been labeled as belonging to, or otherwise being associated with, one or more different classifications or categories. For instance, labeled data may include measurement data that have been labeled as being associated with one or more behavioral phenotypes.

The minute-level measurement data may be aggregated and collected. In an example study, measurement data were acquired across the ten subjects wearing a wearable device for an average of 7 days and 90% of the time, resulting in 1,369.2 hours of physiological measurement data. In this example study, there were 29 disruptive events needing physical restraints for safety. Further, there were 267 and 47 hours where the child was either calm or playful, respectively, with no incidents of disruptive behavior.

Three behavior phenotypes (calm, playful, disruptive) were defined in this study and were annotated using the behavior code described in Table 1 below. Calm (behavior codes 1-4, 7, 8): the child is sedentary while performing routine activities such as reading, lying down, watching movie, talking/interacting with others, or doing their daily homework. Playful (behavior code 5, 6): the child is engaged in an activity of elevated heartrate such as exercising (e.g., on a treadmill), playing a sport (e.g., basketball), or playing with other children (e.g., outdoor gymnasium). Disruptive (behavior code 9-11): child shows uncontrolled aggression/behavior (e.g., tantrum) warranting restraints and/or time-outs. For each of the calm, playful, and disruptive phenotypic annotation on a given day, the corresponding average of the heart rate in the preceding 60 minutes and the durations of sleep stages from the previous night were mapped.

TABLE 1
Example Behavior Phenotypes

| Behavior | |
|---|---|
| Code | Descriptions |
| 1 | Patient is eating breakfast/lunch/dinner/snack |
| 2 | Patient is working on assignments |
| 3 | Patient is watching a movie |
| 4 | Patient is attending a group (quiet activity) |
| 5 | Patient is attending a group (stimulating activity) |
| 6 | Patient is playing outside/gym/treadmill/bike |
| | (physical activity) |
| 7 | Patient visiting with family (specify calm, withdrawn, |
| | agitated, or appropriately stimulating visit) |
| 8 | Patient is meeting with team (specify calm, withdrawn, |
| | agitated, or appropriately stimulating meeting) |
| 9 | Patient is upset, sitting quietly. Refusing to cooperate |
| 10 | Patient is having a tantrum. Minor (Patient's behavior |
| | was disruptive to milieu/setting and required verbal |
| | redirection. Patient was responsive to redirection) |
| 11 | Patient is having a tantrum. Major (Patient's behavior was |
| | disruptive to milieu/setting and required verbal redirection. |
| | Patient was non-responsive or resistant to redirection and |
| | required increased staff or time to demonstrate behavioral |
| | adherence to expectations) |
| 12 | Patient is asleep |
| 13 | Other, specify |

### Heartrate Variations Across Behavior Phenotypes

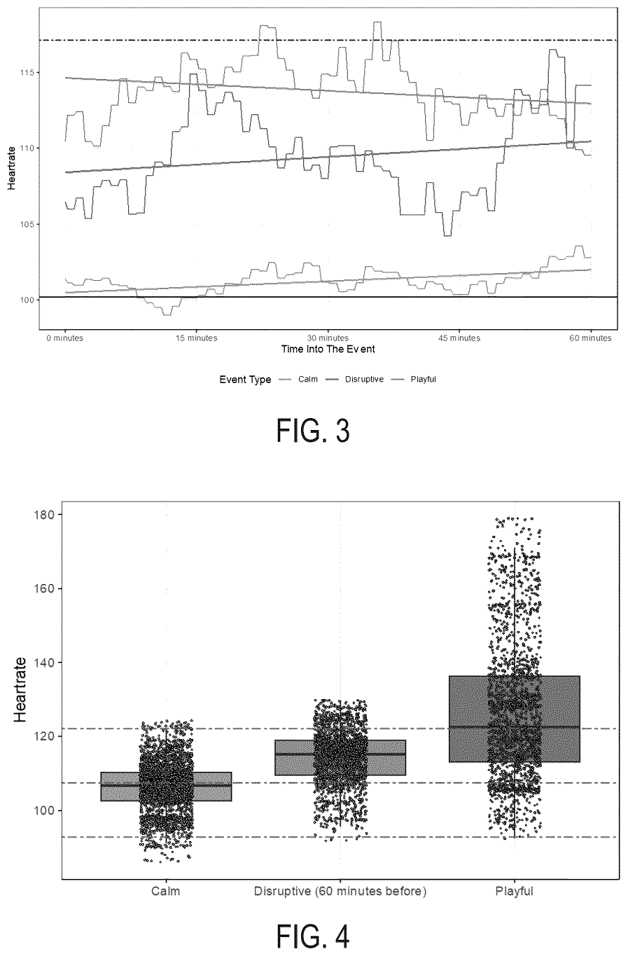

The 15-minute moving heartrate for each minute during a 60-minute window when a child is calm (without disruptive behavior), playful (without disruptive behavior), or leading up to a disruptive behavior event are illustrated in FIG. 3 (the 95% confidence interval around the mean as derived using linear regression). The heartrate during the entire 60 minutes was significantly different across the three behavior phenotypes (p<2×10⁻¹⁶). For the 60-minute duration when subjects were reported calm, there was no difference (p>0.8) between the associated heartrate and the resting heartrate reported by the wearable devices (see FIG. 4).

### Intensity Variations in 60 Minutes of Behavior Phenotypes

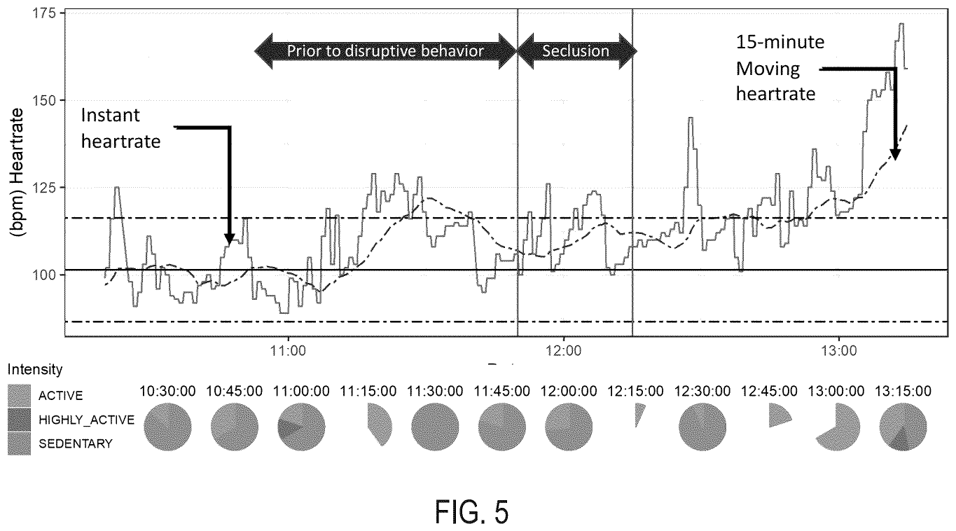

A wearable device may provide different levels of intensity of motor activity, such as Sedentary: little to no movement, Active: engaging in a walk, and Highly Active: engaging in running or jumping jacks. In the 60-minute duration of when subjects were calm or playful (without disruptive behavior) or leading up to disruptive behavior, the proportion of motor activity intensities were significantly different (p<2×10⁻¹⁶, Chi-square test) across the three behavior phenotypes. During the hours the subjects were (a) calm—77% of the hour was reported as sedentary by the watch, and (b) playful—54% of the hour was reported as being active or highly active by the watch. In the hour prior to a disruptive behavior, the subject was sedentary for 63% of the time. A particular instance of this observation is illustrated in FIG. 5, where the subject was reported to be calm while performing a coloring activity then became dysregulated at 11:50 AM when asked to pause for lunch and had to be restrained in the seclusion room until safe behavior was composed.

### Sleep Variations Across Behavior Phenotypes

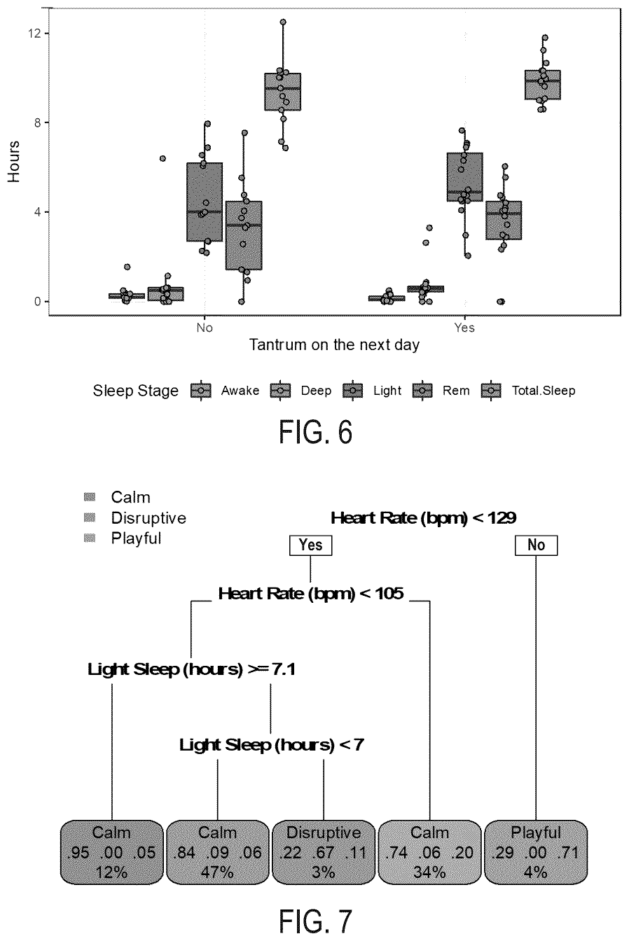

A wearable device may provide the duration and sequence of sleep stages (light, deep, rapid eye movement (REM), and awake). Across all subjects in an example study, the total sleep durations (in hours) or amount of time awake were not significantly different between subjects who exhibited disruptive behavior versus those who did not (p>0.16). However, the durations of REM, light, and deep sleep stages were different between subjects who exhibited disruptive behavior versus those who did not (p≤0.04, see FIG. 6). In subjects who exhibited disruptive behavior, the odds (OR 6) of disruptive behavior was significant (p=0.05) if the duration of light sleep exceeded four hours, and there were no significant associations with the total sleep duration or duration of awake, deep and REM sleep.

### Training the Machine Learning Model(s)

One or more machine learning models (or other suitable machine learning algorithms) are trained on the training data, as indicated at step 204. In general, the machine learning model can be trained by optimizing network or model parameters (e.g., weights, biases, etc.) based on minimizing a loss function. As one non-limiting example, the loss function may be a mean squared error loss function.

Training a machine learning model may include initializing the machine learning model, such as by computing, estimating, or otherwise selecting initial network or model parameters (e.g., weights, biases, etc.). In an example, decision trees were trained to use heartrate (60-minute average) and sleep data to predict whether the child will be calm, playful, or about to be disruptive. Decision trees are non-parametric supervised machine learning algorithms that generate conditional dependency statements (that can be programmed into low-cost smartphones connecting to a wearable device) to indicate the likelihood of an impending event. Ten-fold cross-validation with Chi-square pruning (using RPART package in R) may be conducted to derive the optimal split points for each level of the tree in order to reach the final decision of whether the physiological measurement data was predictive of any of the three behavior states. The conditional dependencies of physiological measurement data predictive of the three behavior states derived from the decision tree (see FIG. 7) were as follows. If the heartrate is >129 bpm, then there is a 71% chance of child being playful. If the heartrate is in the range of 106 to 128 with ≥7 hours of light-sleep (the night before), then there is a 67% chance of an impending disruptive behavior. In all other instances, the child is likely calm. In the 10-fold cross-validation across 10 subjects, the accuracy of predicting the child's behavior state using these conditional dependencies is 80.89%.

In some embodiments, the machine learning model may be periodically re-trained, e.g., on a daily, weekly, monthly, or quarterly basis, as indicated at step 205. In this way, the machine learning model in these embodiments may improve over time to produce more accurate predictions. In some embodiments, this re-training process may use data collected by a wearable device worn by a particular user. In this way, the machine learning model in these embodiments may become customized and optimized over time for that particular user.

### Storing Machine Learning Model(s) for Later Use

The one or more trained machine learning models are then stored for later use, as indicated at step 206. Storing the machine learning model(s) may include storing network or model parameters (e.g., weights, biases, etc.), which have been computed or otherwise estimated by training the machine learning model(s) on the training data. Storing the trained machine learning model(s) may also include storing the particular machine learning model architecture to be implemented. For instance, data pertaining to the decision tree, random forest, or layers in a neural network architecture (e.g., number of layers, type of layers, ordering of layers, connections between layers, hyperparameters for layers) may be stored.

According to an aspect of the present disclosure, a method for predicting disruptive behavior in a subject is provided. The method includes receiving, by a processor, measurement data recorded with a wearable device worn by the subject, wherein the measurement data comprises at least one of motion data, heart rate data, or sleep data. The method also includes accessing, by the processor, a machine learning model trained on training data to monitor signals contained in the measurement data to detect signals that indicate a likelihood of a disruptive behavior. The method further includes applying, by the processor, the measurement data to the machine learning model to generate predictive feature data that predict a likelihood of a disruptive behavior in the subject based on the measurement data. Additionally, the method includes outputting, by the processor, the predictive feature data to a user.

According to other aspects of the present disclosure, the method may include one or more of the following features. The measurement data may comprise heart rate data, and the machine learning model may be trained to detect an elevated heart rate as a signal indicating a likelihood of disruptive behavior. The machine learning model may be trained to detect an average heart rate in a range of 106 to 128 beats per minute over a 10-minute window as a signal indicating a likelihood of disruptive behavior. The measurement data may comprise sleep data, and the machine learning model may be trained to detect a duration of light sleep exceeding four hours as a signal indicating a likelihood of disruptive behavior. The measurement data may comprise motion data, and the machine learning model may be trained to detect a period of sedentary activity followed by increased activity as a signal indicating a likelihood of disruptive behavior. Outputting the predictive feature data may comprise generating an alert indicating the likelihood of disruptive behavior. The alert may be sent to at least one of a parent, a guardian, or a member of a health team associated with the subject. The method may further comprise receiving, by the processor, a time of day associated with the measurement data, and applying, by the processor, the time of day to the machine learning model along with the measurement data. The machine learning model may comprise a decision tree model. The decision tree model may be trained using a chi-square pruning technique to derive optimal split points for predicting the likelihood of disruptive behavior.

According to another aspect of the present disclosure, a method for training a machine learning model to generate predictive feature data that indicate a likelihood of a disruptive behavior in a subject is provided. The method includes accessing, by a processor, training data comprising measurement data acquired from wearable devices worn by a plurality of subjects, wherein the measurement data comprises at least one of motion data, heart rate data, or sleep data. The method also includes assembling, by the processor, the training data into a data structure, wherein the training data includes labeled data associated with one or more behavioral phenotypes. The method further includes initializing, by the processor, a machine learning model with initial model parameters. Additionally, the method includes training, by the processor, the machine learning model on the assembled training data by optimizing the model parameters based on minimizing a loss function. The method also includes storing, by the processor, the trained machine learning model for later use in predicting disruptive behavior in a subject.

According to other aspects of the present disclosure, the method may include one or more of the following features. The behavioral phenotypes may comprise calm, playful, and disruptive behaviors. The labeled data may include annotations of the behavioral phenotypes based on observed behavior of the subjects. The machine learning model may comprise a decision tree model. The method may further comprise performing, by the processor, a cross-validation technique to derive optimal split points for the decision tree model. The cross-validation technique may comprise a ten-fold cross-validation with chi-square pruning. The measurement data may further comprise at least one of respiratory rate data, skin temperature data, electrocardiogramaignal data, blood oxygenation data, or blood pressure data. Assembling the training data may comprise aggregating minute-level measurement data for each subject, and mapping the aggregated measurement data to corresponding behavioral phenotype annotations. Training the machine learning model may comprise optimizing the model parameters to predict a likelihood of disruptive behavior based on at least one of an average heart rate over a specified time window or a duration of a specific sleep stage. The specified time window may be 60 minutes, and the specific sleep stage may be light sleep.

According to other aspects of the present disclosure, a wearable device for predicting disruptive behavior in a subject, the wearable device comprising a computer processor and one or more computer memories operatively coupled to the computer processor. The one or more computer memories may contain computer program instructions capable, when executed by the computer processor, of causing the wearable device to record measurement data, wherein the measurement data is chosen from the group consisting of motion data, heart rate data, and sleep data. The computer program instructions may also cause the wearable device to access a machine learning model, wherein the machine learning model has been trained on training data to monitor signals contained in the measurement data to detect signals that indicate a likelihood of a disruptive behavior for an individual, wherein the machine learning model is a tree-based model, wherein the tree-based model is a decision tree model or a random forest model. The computer program instructions may also cause the wearable device to apply the measurement data to the machine learning model, generating predictive feature data that predict a likelihood of a disruptive behavior in the subject based on the measurement data. The computer program instructions may also cause the wearable device to output the predictive feature data, wherein the predictive feature data indicate predictive scores or probabilities of different behavioral phenotypes.

According to other aspects of the present disclosure, a computer program product for predicting disruptive behavior in a subject, the computer program product comprising a computer readable storage medium having program instructions embodied therewith, the program instructions executable by a computer to perform a method comprising: (a) receiving by a processor, measurement data recorded with a wearable device worn by a subject, wherein the measurement data comprise motion data, heart rate data, and sleep data; (b) accessing a machine learning model with the processor, wherein the machine learning model has been trained on training data to monitor signals contained in the measurement data to detect signals that indicate a likelihood of a disruptive behavior for an individual, wherein the machine learning model is a tree-based model, wherein the tree-based model is a decision tree model or a random forest model; (c) applying the measurement data to the machine learning model with the processor, generating predictive feature data that predict a likelihood of a disruptive behavior in the subject based on the measurement data; (d) outputting the predictive feature data with the processor, wherein the predictive feature data indicate predictive scores or probabilities of different behavioral phenotypes.

### Example

The disclosed systems and methods were evaluated in an example study. The study was a double-blind (therapist, patient and patient's parents/caregivers were blinded) RCT.

### Methods

Children participants were aged 3-7 years, with Externalizing Behavior Problems (EBP) Severity rated above the clinically significant range (I-score≥120; T-score≥60), willing to wear a study smartwatch, and able to speak and understand English. Children were allowed to start and stop medications during the study to reflect naturalistic treatment and bolster the generalizability of the study. A PCIT provider managed all psychotropic medications during the study. Children with autism spectrum disorder (ASD) could receive Applied Behavioral Analysis (ABA) therapy concurrently with PCIT as it is a standard practice in the community. Children who were receiving Play Therapy, Child Parent Psychotherapy, and/or any other similar therapies prior to starting PCIT were asked to stop them or put them on pause during the study.

Simple randomization was used to generate assignments (by PEC) between two study arms and participants receiving 50 consecutive identification numbers. Only study coordinators and digital health technology staff were aware of the study arm assignments to set up the EMA on the mobile devices. The PCIT provider was blinded to the group assignment until all follow-up visits were completed and data analyses were to be commenced. Assessment of the blinding process was conducted using the James Blinding Index by asking both the therapist and the parent for their guess on the treatment arm or an “I don't know” statement.

All accrued parent-child dyads received a fixed number of 12 PCIT sessions using standard protocol as part of routine care. With one session per week, the minimum time to study completion was 12 weeks, while allowing gaps between sessions that accommodated for schedule conflicts (e.g., parent busy at work, ill child/provider).

All participating dyads were issued a Garmin vivosmart4 smartwatch with a choice between two colors (rose gold or black) and two sizes of strap (small/medium or large). Smartwatch data was collected via Fitabase. The choice of the smartwatch was motivated by cross-platform compatibility (between iOS and Android ecosystems), and minimal screen size that would fit on a child's wrist. The dyads were requested to maximize wearing the watch to meet the adherence threshold of 70% of time in a 24-hour day. This threshold was based on adherence needed in continuous monitoring of physiological and biological measures with DHTs in other chronic conditions for meaningful imputation. Participants were also asked to remove the watch during bathing and dinner time to clean and charge the device.

The child's smartwatch was paired to the parent's smartphone (or a study-provided smartphone if the parent did not possess one), and the parent's smartwatch was paired to a study issued mobile device. In the PCIT-AI arm, pairing the child's smartwatch to the parent's phone facilitated a mobile app (on parent's smartphone) to collect instant heart rate data from the child's watch to trigger a message if the average heart rate in a 10-minute window was in the range of 105 to 129 bpm between 7 am to 8 pm. Reminders to check the real-time alert was sent every 20 minutes for three times. Parents in both study arms were additionally requested to log the start and end times of a tantrum (even if an EMA was not triggered in PCIT-AI) using the “tantrum log” assessment on a mobile app. Additionally, parents in the PCIT-AI arm were also requested to log any observed tantrum in response to the alert and report the child's functioning by choosing among “angry,” “anxious,” “calm,” “irritated,” “oppositional,” “playful,” and “sad.”.

The primary outcome was adherence defined as the percent time that the study smartwatch is worn per day by participants during the course of PCIT (automatically calculated by the smartwatch based on detecting a pulse). The expected adherence was ≥70% across the 12 sessions of PCIT. Secondary outcomes were the following: (1) Changes in ECBI's intensity and problem subscales measured at enrollment (pre—prior to first PCIT session) and a week after the 12th PCIT session (post). Percent change was defined as ((pre-post)*100/pre), and absolute change was defined as (pre-post); (2) Absolute changes (pre-post) in PSQ. An exploratory outcome was the difference in tantrum durations between PCIT-AI and PCIT-TAU arms. Tantrum occurrences and durations were collected with parental EMA. Tantrum durations were derived as the difference between start and end time (in minutes) of the tantrum logged in the mobile app.

The study team provided support to 1) setup the smartwatches for the dyad at enrollment, 2) prepare the mobile application on the respective mobile devices, and 3) manage an 18-hour (6 am to midnight) study-dedicated email address that participants were asked to email should they encounter any technical difficulties. Solutions to any technical issues were resolved via email, a phone call with a study team member, or in-person before or after a PCIT session. Participants were asked to not wear the watch if there was any skin irritation (an anticipated adverse reaction) in the wrist area and encouraged to resume wearing the watch when deemed comfortable.

For statistical analyses performed in this example study, demographic and clinical characteristics are summarized using medians [interquartile range (IQR)] for continuous variables and frequencies (percentages) for categorical variables. These characteristics are presented overall and separately for participants based on treatment arm. T-tests or Wilcoxon rank sum tests (for continuous variables) and chi-square or Fisher's exact test (for categorical variables) were used for comparisons between randomized treatment groups.

Percent wear time and nights slept with watch were analyzed using two-sample t-tests. Continuous outcomes (ECBI changes, tantrum durations in minutes) were analyzed using linear regression. In addition to unadjusted analyses, adjusted analyses were performed to account for potential confounding. Covariates included baseline score, child age, child sex, interaction of child diagnosed with ADHD and child taking stimulants, interaction of parent age and education level, and interaction of parent sex and marital status. Cox proportional hazard regression was used to estimate study completion between the randomized treatment groups. A Kaplan-Meier plot was used to visualize the dropout rates during the study by treatment group. James Blinding Indexes for both provider and parents was obtained to assess whether satisfactory blinding was achieved in the RCT. If the blinding index is 1, perfect blinding is achieved, and a value of 0 indicates full unblinding. A study is deemed to achieve satisfactory blinding if the lower bound of the confidence interval of blinding index is >0.524. Differences in tantrum durations between treatment groups were estimated using two-sample t-tests. Odds ratio (with 95% Cl) for tantrums lasting ≥15 minutes or ≥25 minutes was computed using Fishers exact test. Cohens' d was used to estimate the effect sizes of ECBI changes between randomized treatment groups. Finally, the validation of the smartwatch biomarker (heart rate) that was used to trigger alerts to parents of an impending tantrum in the PCIT-AI arm was validated in PCIT-TAU subjects.

In all cases, p-values of 0.05 or less were considered statistically significant. Complete case analysis was used. Data management and statistical analysis were performed using SAS 9.4 (SAS Institute Inc, Cary, North Carolina) and R version 4.1.2 (RStudio Team 2021, Boston, Massachusetts).

### Results

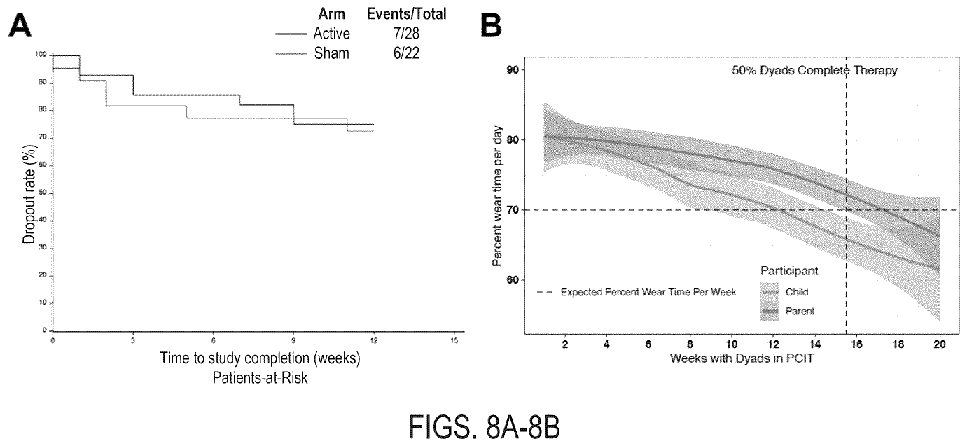

A total of 218 dyads were screened for eligibility and 50 were consented and randomized (n=28 for PCIT-AI; n=22 for PCIT-TAU). Twenty-one dyads of 28, and 16 dyads of 22 completed the 12 sessions of PCIT in the PCIT-AI and PCIT-TAU arms respectively. Using PCIT-TAU as the reference group in the survival analyses, the Cox proportional hazards ratio is 0.87 (95% Cl: 0.29, 2.59; p=0.803), indicating no significant differences in rates of study completion in treatment groups (see Kaplan-Meier plot of dropout by treatment arm in FIG. 8A). Fifty percent of dyads completed the 12 PCIT sessions in 15 weeks (see FIG. 8B). The James Blinding Index for provider and parents are 0.68 [0.55,0.81] and 0.76 [0.63,0.89] respectively, indicating satisfactory blinding as lower estimate of the Cl are >0.5.

Among all enrolled dyads, the median age of the child in the study was 5 years (IQR 4.0, 6.0), 34 of 50 children were male (68%), and 43 of the 50 participating primary parents were females (86%). Attention-deficit/hyperactivity disorder (ADHD) was the most common comorbidity present in the enrolled children (54%) and 50% of children were treated with stimulants. There were five children diagnosed with autism spectrum disorder (ASD) (all in the PCIT-AI arm). Except for education status of the primary participating parent and ASD diagnosis in the child patient, all other patient demographics did not statistically differ between treatment arms. Seven and six dyads did not complete the study in the PCIT-AI and PCIT-TAU arms respectively.

Among those who completed the study, children wore the watch an average of 79.6% and 71.5% of the time (p=0.01), and parents wore the watch 76.9% and 79.8% of the time (p=0.70) in the PCIT-AI and PCIT-TAU arms respectively. In both arms, the median nights per week that the watch was worn during sleep was 7. The adherence in children who did not complete the study was 39.6% with dyads not starting PCIT, lost to follow-up, or parents who were unable to attend PCIT sessions.

Demonstrating the feasibility of the engineered ecosystem to deliver real-time alerts to parents from their child's smartwatch, 573 alerts were generated in the PCIT-AI arm. The median time from when the alert was generated to when parents responded to it was 3.65 seconds, and the response time ranged from 0.12 seconds to 1.42E5 seconds.

The difference in percent change in ECBI intensity between PCIT-AI and PCIT-TAU was 16.22 (95 % Cl: −7.72, 40.16; p=0.173) after adjusting for baseline severity, child age, child sex, interaction between child ADHD diagnosis and child on stimulants, interaction between parent age and education level, and interaction between parent sex and marital status. Cohen's d effect estimates for the difference in percent change in ECBI intensity between PCIT-AI and PCIT-TAU arm was 0.37. The adjusted absolute change in PSQ when comparing PCIT-AI to PCIT-TAU study arm was not significantly different (Est: −0.95, 95% Cl: −3.51, 1.62; p=0.451). The absolute change in ECBI intensity, percent change in ECBI problem, and absolute change in ECBI problem were not statistically significant when comparing PCIT-AI to PCIT-TAU, and associated Cohen's d effect estimates were small.

Parents in the study logged a total of 932 tantrums as EMAs using the provided mobile application. When not stratifying by treatment groups, the mean (SD) duration of tantrums in CDI and PDI sessions were 15.2 (28.1) and 14.2 (18.0) minutes respectively and did not differ statistically (p=0.52).

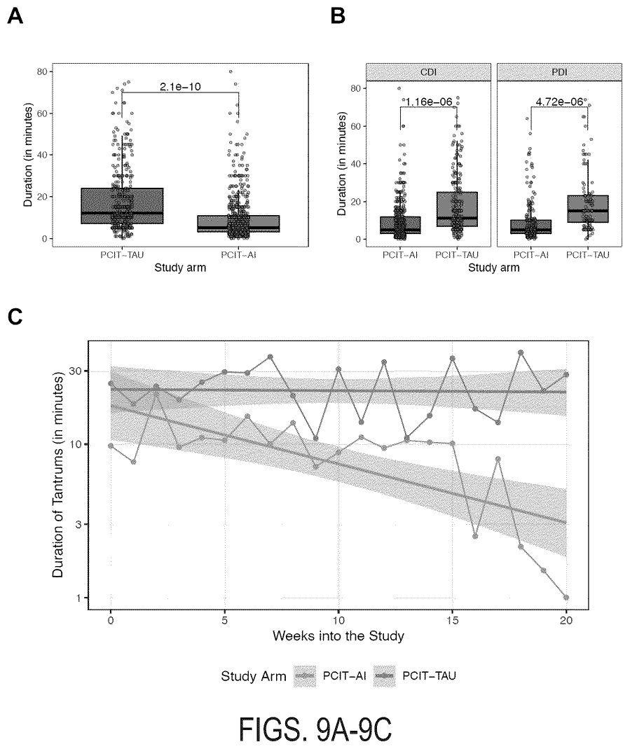

Parents in the PCIT-AI arm logged 573 tantrums, and parents in the PCIT-TAU logged 359 tantrums. In the PCIT-AI arm, 326 (57%) of the 573 tantrums were logged in response to platform generated alerts of potential impending tantrums based on the child's heart rate. The remaining 247 (43%) of 573 tantrums were reported by the parent independent of digital feedback. The mean (SD) duration of tantrums was 10.4 (20.8) minutes in the PCIT-AI arm and 22.1 (30.0) minutes in the PCIT-TAU arm, and was significantly lower in the PCIT-AI arm after adjusting for child age, child sex, interaction between child ADHD diagnosis and child on stimulants, interaction between parent age and education level, and interaction between parent sex and marital status (p<0.001; see FIG. 9A). Across CDI sessions of PCIT, the mean (SD) duration of tantrums was 10.7 (23.9) minutes and 22.3 (32.4) minutes in the PCIT-AI and PCIT-TAU arms respectively, and the difference in mean duration was statistically significant (p<0.001; see FIG. 9B). Across PDI sessions of PCIT, the mean (SD) duration of tantrums was 9.83 (9) minutes and 21.5 (23.8) minutes in the PCIT-AI and PCIT-TAU arms respectively, and the difference in mean duration was statistically significant (p<0.001). Across the PCIT sessions, the average duration of tantrums was reduced in the PCIT-AI in comparison with the PCIT-TAU treatment group (see FIG. 9C).

While the odds ratio of tantrums lasting ≥15 minutes or ≥25 minutes in the PCIT-TAU arm in comparison with the PCIT-AI arm was 3.66 (95% Cl [2.7, 4.9]; p<0.001) and 3.3 (95% Cl [2.3, 4.9]; p<0.001), the durations of these longer tantrums were not statistically significant between treatment arms (p>0.05). In the PCIT-AI arm wherein parents reported the child's functioning following an observed and predicted tantrum in the EMA, the odds of the child being either playful or calm was 2.8 (95% Cl [1.4, 5.5]; p=0.002) if the tantrum lasted less than 15 minutes.

### Discussion

In this example study, the disclosed systems and methods demonstrated the feasibility, adherence, and utilization of a digital health technology (DHT) ecosystem including of wearables and a mobile application that informs parents of impending tantrums in their young children with disruptive behaviors. Children in the study arm receiving PCIT augmented with real-time alerts had a reduced duration of tantrums, and reduced odds ratio of tantrums lasting ≥15—or ≥25 minutes compared to children receiving PCIT without real-time alerts (an active control arm). Findings from the present study could inform the design, refinement of smartwatch biomarkers, and further evaluation of DHTs in PCIT for precision care of children diagnosed with disruptive behavior disorders.

The study demonstrated reduction of tantrum durations reported with parental EMA supported by from real-time alerts generated using DHTs. The disclosed systems and methods may address limitations in traditional rating scales that retrospectively assess behavioral events and reports of improvement. The types and the frequency of tantrum episodes have been associated with more serious clinical problems in retrospective analyses, and recommendations have been made by The American Academy of Child and Adolescent Psychiatry for affected families to seek out treatment with evidenced based behavioral therapies such as PCIT. In this context, a digital ecosystem such as the one provided by the disclosed systems and methods may serve as a scalable and low-touch technology for managing a child's behavior while on waitlists for therapy or can be used in conjunction with internet-delivered therapies if families are residing in communities with limited pediatric mental health infrastructure.

### Computer Systems

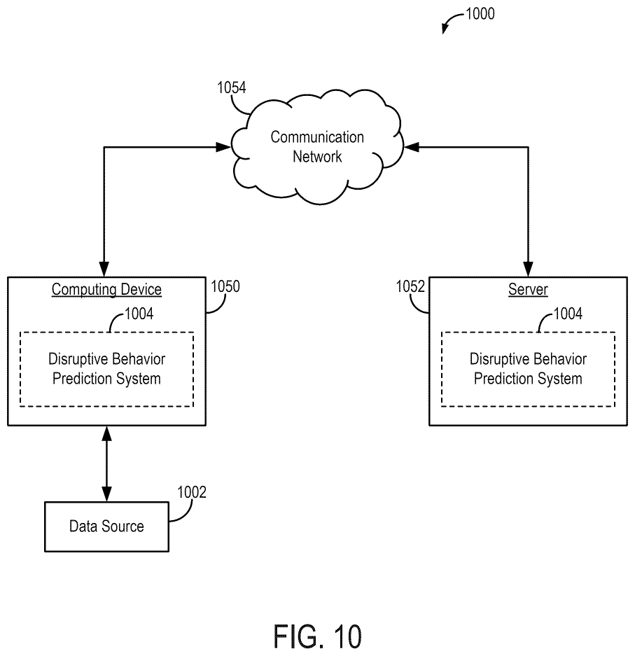

FIG. 10 illustrates an example of a system 1000 for predicting disruptive behavior in an individual in accordance with some embodiments of the systems and methods described in the present disclosure. As shown in FIG. 10, a computing device 1050 can receive one or more types of data (e.g., measurement data, which may include motion data, heart rate data, and/or sleep data) from data source 1002. In some embodiments, computing device 1050 can execute at least a portion of a disruptive behavior prediction system 1004 to predict the likelihood of disruptive behavior in a child from data received from the data source 1002.

Additionally or alternatively, in some embodiments, the computing device 1050 can communicate information about data received from the data source 1002 to a server 1052 over a communication network 1054, which can execute at least a portion of the disruptive behavior prediction system 1004. In such embodiments, the server 1052 can return information to the computing device 1050 (and/or any other suitable computing device) indicative of an output of the disruptive behavior prediction system 1004.

In some embodiments, computing device 1050 and/or server 1052 can be any suitable computing device or combination of devices, such as a desktop computer, a laptop computer, a smartphone, a tablet computer, a wearable computer, a server computer, a virtual machine being executed by a physical computing device, and so on. The computing device 1050 and/or server 1052 can also reconstruct images from the data.

In some embodiments, data source 1002 can be any suitable source of data (e.g., measurement data), such as a wearable device, another computing device (e.g., a server storing measurement data), and so on. In some embodiments, data source 1002 can be local to computing device 1050. For example, data source 1002 can be incorporated with computing device 1050 (e.g., computing device 1050 can be configured as part of a device for measuring, recording, estimating, acquiring, or otherwise collecting or storing data). As another example, data source 1002 can be connected to computing device 1050 by a cable, a direct wireless link, and so on. Additionally or alternatively, in some embodiments, data source 1002 can be located locally and/or remotely from computing device 1050, and can communicate data to computing device 1050 (and/or server 1052) via a communication network (e.g., communication network 1054).

In some embodiments, communication network 1054 can be any suitable communication network or combination of communication networks. For example, communication network 1054 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 1054 can be a local area network, a wide area network, a public network (e.g., the Internet), a private or semi-private network (e.g., a corporate or university intranet), any other suitable type of network, or any suitable combination of networks. Communications links shown in FIG. 10 can each be any suitable communications link or combination of communications links, such as wired links, fiber optic links, Wi-Fi links, Bluetooth links, cellular links, and so on.

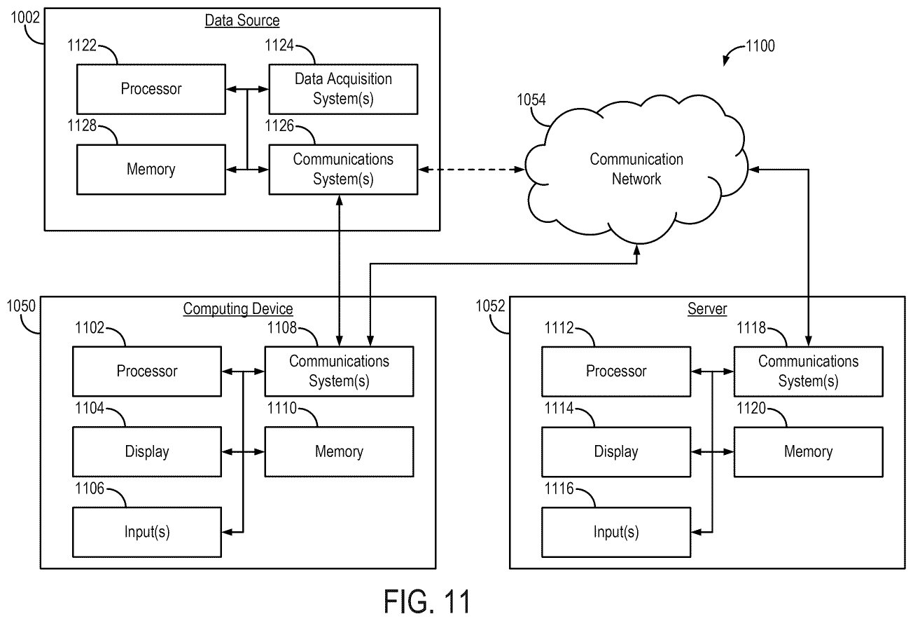

Referring now to FIG. 11, an example of hardware 1100 that can be used to implement data source 1002, computing device 1050, and server 1052 in accordance with some embodiments of the systems and methods described in the present disclosure is shown.

As shown in FIG. 11, in some embodiments, computing device 1050 can include a processor 1102, a display 1104, one or more inputs 1106, one or more communication systems 1108, and/or memory 1110. In some embodiments, processor 1102 can be any suitable hardware processor or combination of processors, such as a central processing unit (“CPU”), a graphics processing unit (“GPU”), and so on. In some embodiments, display 1104 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 1106 can include any suitable input devices and/or sensors that can be used to receive user input, such as a keyboard, a mouse, a touchscreen, a microphone, and so on.

In some embodiments, communications systems 1108 can include any suitable hardware, firmware, and/or software for communicating information over communication network 1054 and/or any other suitable communication networks. For example, communications systems 1108 can include one or more transceivers, one or more communication chips and/or chip sets, and so on. In a more particular example, communications systems 1108 can include hardware, firmware, and/or software that can be used to establish a Wi-Fi connection, a Bluetooth connection, a cellular connection, an Ethernet connection, and so on.

In some embodiments, memory 1110 can include any suitable storage device or devices that can be used to store instructions, values, data, or the like, that can be used, for example, by processor 1102 to present content using display 1104, to communicate with server 1052 via communications system(s) 1108, and so on. Memory 1110 can include any suitable volatile memory, non-volatile memory, storage, or any suitable combination thereof. For example, memory 1110 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 1110 can have encoded thereon, or otherwise stored therein, a computer program for controlling operation of computing device 1050. In such embodiments, processor 1102 can execute at least a portion of the computer program to present content (e.g., images, user interfaces, graphics, tables), receive content from server 1052, transmit information to server 1052, and so on. For example, the processor 1102 and the memory 1110 can be configured to perform the methods described herein (e.g., the method of FIG. 1, the method of FIG. 2).

In some embodiments, server 1052 can include a processor 1112, a display 1114, one or more inputs 1116, one or more communications systems 1118, and/or memory 1120. In some embodiments, processor 1112 can be any suitable hardware processor or combination of processors, such as a CPU, a GPU, and so on. In some embodiments, display 1114 can include any suitable display devices, such as an LCD screen, LED display, OLED display, electrophoretic display, a computer monitor, a touchscreen, a television, and so on. In some embodiments, inputs 1116 can include any suitable input devices and/or sensors that can be used to receive user input, such as a keyboard, a mouse, a touchscreen, a microphone, and so on.

In some embodiments, communications systems 1118 can include any suitable hardware, firmware, and/or software for communicating information over communication network 1054 and/or any other suitable communication networks. For example, communications systems 1118 can include one or more transceivers, one or more communication chips and/or chip sets, and so on. In a more particular example, communications systems 1118 can include hardware, firmware, and/or software that can be used to establish a Wi-Fi connection, a Bluetooth connection, a cellular connection, an Ethernet connection, and so on.

In some embodiments, memory 1120 can include any suitable storage device or devices that can be used to store instructions, values, data, or the like, that can be used, for example, by processor 1112 to present content using display 1114, to communicate with one or more computing devices 1050, and so on. Memory 1120 can include any suitable volatile memory, non-volatile memory, storage, or any suitable combination thereof. For example, memory 1120 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1120 can have encoded thereon a server program for controlling operation of server 1052. In such embodiments, processor 1112 can execute at least a portion of the server program to transmit information and/or content (e.g., data, images, a user interface) to one or more computing devices 1050, receive information and/or content from one or more computing devices 1050, receive instructions from one or more devices (e.g., a personal computer, a laptop computer, a tablet computer, a smartphone), and so on.

In some embodiments, the server 1052 is configured to perform the methods described in the present disclosure. For example, the processor 1112 and memory 1120 can be configured to perform the methods described herein (e.g., the method of FIG. 1, the method of FIG. 2).

In some embodiments, data source 1002 can include a processor 1122, one or more data acquisition systems 1124, one or more communications systems 1126, and/or memory 1128. In some embodiments, processor 1122 can be any suitable hardware processor or combination of processors, such as a CPU, a GPU, and so on. In some embodiments, the one or more data acquisition systems 1124 are generally configured to acquire data, such as physiological measurement data, and can include one or more sensors of a wearable device. Additionally or alternatively, in some embodiments, the one or more data acquisition systems 1124 can include any suitable hardware, firmware, and/or software for coupling to and/or controlling operations of a wearable device or one or more sensors of the wearable device. In some embodiments, one or more portions of the data acquisition system(s) 1124 can be removable and/or replaceable.

Note that, although not shown, data source 1002 can include any suitable inputs and/or outputs. For example, data source 1002 can include input devices and/or sensors that can be used to receive user input, such as a keyboard, a mouse, a touchscreen, a microphone, a trackpad, a trackball, and so on. As another example, data source 1002 can include any suitable display devices, such as an LCD screen, an LED display, an OLED display, an electrophoretic display, a computer monitor, a touchscreen, a television, etc., one or more speakers, and so on.

In some embodiments, communications systems 1126 can include any suitable hardware, firmware, and/or software for communicating information to computing device 1050 (and, in some embodiments, over communication network 1054 and/or any other suitable communication networks). For example, communications systems 1126 can include one or more transceivers, one or more communication chips and/or chip sets, and so on. In a more particular example, communications systems 1126 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 1128 can include any suitable storage device or devices that can be used to store instructions, values, data, or the like, that can be used, for example, by processor 1122 to control the one or more data acquisition systems 1124, and/or receive data from the one or more data acquisition systems 1124; to generate images from data; present content (e.g., data, images, a user interface) using a display; communicate with one or more computing devices 1050; and so on. Memory 1128 can include any suitable volatile memory, non-volatile memory, storage, or any suitable combination thereof. For example, memory 1128 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1128 can have encoded thereon, or otherwise stored therein, a program for controlling operation of data source 1002. In such embodiments, processor 1122 can execute at least a portion of the program to generate images, transmit information and/or content (e.g., data, images, a user interface) to one or more computing devices 1050, receive information and/or content from one or more computing devices 1050, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for predicting disruptive behavior in a subject, the method comprising:
(a) receiving by a processor, measurement data recorded with a wearable device worn by a subject, wherein the measurement data comprise motion data, heart rate data, and sleep data;
(b) accessing a machine learning model with the processor, wherein the machine learning model has been trained on training data to monitor signals contained in the measurement data to detect signals that indicate a likelihood of a disruptive behavior for an individual, wherein the machine learning model is a tree-based model, wherein the tree-based model is a decision tree model or a random forest model;
(c) applying the measurement data to the machine learning model with the processor, generating predictive feature data that predict a likelihood of a disruptive behavior in the subject based on the measurement data;
(d) outputting the predictive feature data with the processor, wherein the predictive feature data indicate predictive scores or probabilities of different behavioral phenotypes.

2. The method of claim 1, wherein the heart rate data comprise a moving average of heart rate, wherein the moving average comprises a 15-minute moving average.

3. The method of claim 1, wherein the measurement data further comprise a time of day.

4. The method of claim 1, wherein the motion data comprise duration of time measured in at least one of a plurality of activity levels.

5. The method of claim 4, wherein the plurality of activity levels comprises a sedentary activity level, an active activity level, and a highly active activity level.

6. The method of claim 1, wherein the heart rate data comprise at least one of an active heart rate or a resting heart rate.

7. The method of claim 1, wherein the sleep data comprise at least one of duration of time measured in at least one of a plurality of sleep stages or a sequence of sleep stages.

8. The method of claim 7, wherein the plurality of sleep stages comprises a light sleep stage, a deep sleep stage, a rapid eye movement (REM) stage, and an awake stage.

9. The method of claim 1, further comprising generating a report with the processor and outputting the report to a user when the predictive feature data indicate that a disruptive behavior is predicted in the measurement data.

10. The method of claim 1, wherein the plurality of behavioral phenotypes comprises a calm phenotype, a playful phenotype, and a disruptive phenotype.

11. The method of claim 1, wherein outputting the predictive feature data comprises generating an alert based on the predictive feature data and sending the alert via the processor to at least one of a parent of the subject, a guardian of the subject, or a health team member, wherein the alert comprises a text alert that indicates that a disruptive behavior is predicted for the subject based on the measurement data.

12. The method of claim 1, further comprising
accessing, with the processor, the training data;
training, using the training data, with the processor, the machine learning model to monitor signals contained in the measurement data to detect signals that indicate the likelihood of the disruptive behavior for the individual.

13. The method of claim 12, further comprising:
retraining, with the processor, the machine learning model using data collected by another wearable device worn by another subject.

14. A method for training a machine learning model to generate predictive feature data that indicate a likelihood of a disruptive behavior in a subject, the method comprising:
accessing, by a processor, training data comprising measurement data acquired from wearable devices worn by a plurality of subjects, wherein the measurement data comprises at least one of motion data, heart rate data, or sleep data;
assembling, by the processor, the training data into a data structure, wherein the training data includes labeled data associated with one or more behavioral phenotypes;
initializing, by the processor, a machine learning model with initial model parameters;
training, by the processor, the machine learning model on the assembled training data by optimizing the model parameters based on minimizing a loss function; and
storing, by the processor, the trained machine learning model for later use in predicting disruptive behavior in a subject.

15. The method of claim 14, wherein the behavioral phenotypes comprise a calm phenotype, a playful phenotype, and a disruptive phenotype.

16. The method of claim 15, wherein the labeled data includes annotations of the behavioral phenotypes based on observed behavior of the plurality of subjects.

17. The method of claim 14, wherein the machine learning model comprises a decision tree model.

18. The method of claim 14, wherein the measurement data further comprises at least one of respiratory rate data, skin temperature data, electrocardiogramal data, blood oxygenation data, or blood pressure data.

19. The method of claim 14, wherein assembling the training data comprises:
aggregating minute-level measurement data for each subject in the plurality of subjects; and
mapping the aggregated measurement data to corresponding behavioral phenotype annotations.

20. The method of claim 14, wherein training the machine learning model comprises optimizing the model parameters to predict a likelihood of disruptive behavior based on at least one of an average heart rate over a specified time window or a duration of a specific sleep stage.
